(19) United States
(12) Patent Application Publication
(10) Pub. No.: US 2004/0219314 A1
(43) Pub. Date: Nov. 4, 2004

(54) Impact attenuator for a landing load

(76) Inventor: Glen J. Brown, Santa Cruz, CA (US)

Correspondence Address: Frank C. Price, 13812 SAND-HURST PL, Santa Ana, CA, 92705, US

(21) Appl. No.: 10/425,014

(22) Filed: Apr. 29, 2003

(51) Int. Cl. B32B 1/02

(52) U.S. Cl. 428/34.1

(57) ABSTRACT

Inflating conical legs are mounted on a structure that needs protection against destruction upon impact with the ground as it descends at a potentially destructive velocity. The legs are inflated before impact and they deflate with the pressure caused by the compression forces of impact through an exhaust valve at a rate designed, in conjunction with the conical shape of the legs, to preclude an excessive deceleration rate for the overall structure during impact.

No Federally sponsored research or development funds were used in the creation of the material of this application.

### BACKGROUND OF THE INVENTION

The most efficient design for parachuting loads to the ground will always use high enough drop speed in the parachute that a ground impact attenuation system will be involved. In fact, the optimum overall system will always have a smaller parachute with a higher drop speed and with a ground impact attenuator to preserve the load. The traditional methods for impact attenuation are crush structures, such as paper honeycomb, plastic foam and low-pressure airbags.

Paper honeycomb and plastic foams are extremely effective decelerators, but have these disadvantages:

High bulk: honeycomb is not stowable; plastic foam deployed by chemical reaction is not environmentally or logistically desirable;

Single use: honeycomb must be replaced after each use, its high bulk creates storage and transportation problems;

Variable crush force: force varies with angle of impact; lateral velocity reduces effectiveness.

These are not serious disadvantages for most cargo air-drop operations, where paper honeycomb will remain the attenuation material of choice. However, in operations where weight, bulk or aerodynamic efficiency are important, such as spacecraft and crew escape capsule recovery, a lightweight, deployable, re-usable attenuator is needed.

Airbags have been used successfully for some time in applications requiring deployable impact attenuation. Disadvantages of low-pressure airbags are:

Poor lateral stiffness and resistance to roll-over: once bag starts to deflect there is no resistance to lateral movement;

Low dynamic efficiency: rapid rise in force during compression phase followed by rapid drop in force as pressure is not maintained through rapidly decreasing orifice flow;

Bulky packaging: bag materials make direct contact with the surface and so must be thick and heavy compared to the basic burst strength requirement.

### BRIEF SUMMARY OF THE INVENTION

The invented system provides improvements in dynamic efficiency, stability, resistance to rollover, and increased effectiveness for a given weight and stowed volume.

The basic system element is a high-pressure inflatable conical leg. An impact attenuation system consists of multiple legs, arranged in a stable configuration of three or more legs attached to the bottom surface of a vehicle or payload. Each leg has the form of a truncated cone, with the large diameter at the payload attachment and the small diameter at the end of the leg. A leg assembly includes an inflation system, a pop-off valve closing a flow metering orifice, an attachment flange at the large diameter end and a skid at the end of the leg.

Effective impact attenuation is provided by a system that produces a nearly-constant deceleration force over a long effective stroke. A pressurized truncated cone with out-flow through a fixed orifice operates in the following manner: Upon impact the small diameter end of the inflatable structure begins to “crush”. Over-pressure builds to a level that opens an out-flow orifice, which is sized to maintain a pressure at that flow rate that produces the desired deceleration of the payload. As the payload decelerates, the contact area and rate of volume change both increase, because of the taper of the leg, preventing an early decrease in the retarding force. (A decreasing retarding force is a characteristic of most airbags with fixed out-flow orifices.)

### BRIEF DESCRIPTION OF THE DRAWINGS

FIG. 1 illustrates the elements of the high pressure impact attenuator.

FIG. 2 illustrates a load-carrying platform with impact-attenuation legs.

### DETAILED DESCRIPTION

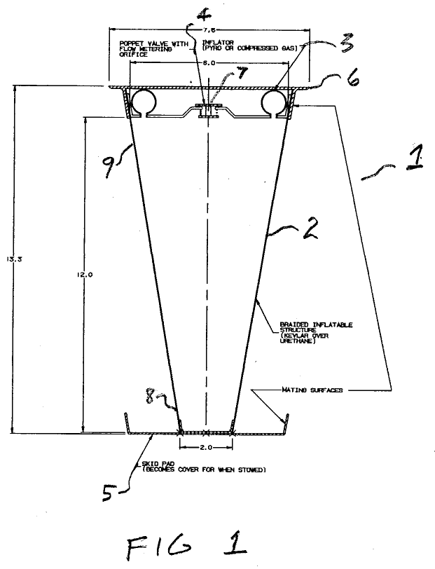

FIG. 1 illustrates the elements of the impact attenuator leg 1. It has a truncated conical shape. The construction of the inflatable envelope 2 (or conical bag) is a special braided sheet material of a high tenacity fiber matrix. The inflator 3 and pop-off poppet valve 4 are shown in schematic form. The leg 1 can be stowed by folding the envelope into itself with a series of concentric folds until the skid pad 5 rests against the base flange 6.

The basic system element is the high-pressure inflatable conical leg 1. This is used in an impact attenuation system consisting of multiple legs, arranged in a stable configuration of three or more legs attached to the bottom surface of a vehicle or payload Effective impact attenuation is provided by this system that produces a nearly-constant deceleration force over a long effective stroke. A pressurized truncated cone with out-flow through a fixed orifice operates in the following manner: Upon impact the small diameter end of the inflatable structure begins to “crush”. Over-pressure builds to a level that opens an out-flow orifice 7, which is sized to maintain a pressure at that flow rate that produces the desired deceleration of the payload. As the payload decelerates, the contact area and rate of volume change both increase, because of the taper of the leg, preventing an early decrease in the retarding force.

It is essential that the inflatable structure will “crush” progressively from the small diameter end 8 to the large diameter end 9 without buckling at the top of the leg. Splayed legs and horizontal velocity on impact both produce lateral end forces and leg bending that might tend to buckle an inflated leg. However, for a given ratio of lateral end force to normal force there is a critical minimum leg taper that will assure progressive bottom-up crush without buckling. For example, a leg with taper of a cone and length to diameter ratio of 3.09 will crush from the bottom-up rather than buckle with a lateral force at the end of a leg is as much as 1.0 times the normal force (a friction coefficient of 1.0).

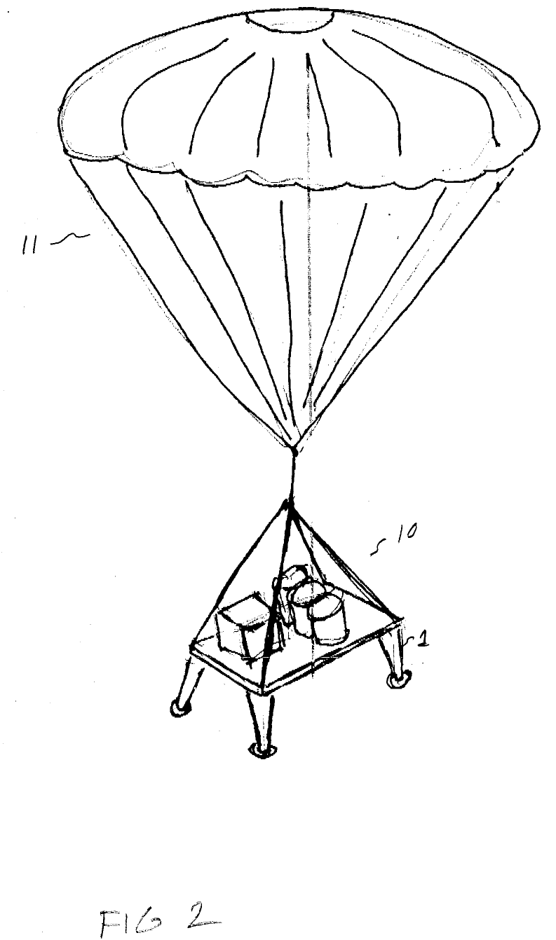

FIG. 2 shows a load-carrying platform 10 suspended from a parachute 11 with four inflated impact attenuating legs 1 already inflated, ready for touchdown. The platform could have any number of legs.

These attenuators can be designed with an inflated pressure to match the design impact velocity and the allowable g-force for survival of the payload. They can be designed to not exceed a given limiting deceleration spike during the period of impact and crushing of the attenuators. The attenuators can be pre-pressurized and deployed before impact either by a central gassing system or by individual cartridges for each leg.

I claim:

1. An impact attenuator for reducing the velocity difference of two converging bodies as said bodies approach each other, said attenuator providing interference against relative motion between said bodies, said attenuator absorbing the kinetic energy of differential motion and gradually lowering the relative velocity during convergence, comprising:
an inflated protuberance on one of the bodies, said protuberance in the shape of a truncated cone, said cone having flat ends, a smaller and a larger, said larger end containing a pop-off valve closing a metering orifice;
an inflation system to pressurize the structure of said inflated protuberance;
said protuberance, upon the approaching contact of the two said converging bodies, emitting its inflation gas and progressively collapsing, beginning at the smaller end of said truncated cone, said smaller end protruding from said one of the bodies, said larger end mounted against said one of the bodies.

2. The attenuator of claim 1 in which more than one truncated cone is utilized.

3. The attenuator of claim 1 in which the protuberance is made of flexible sheet material containing a reinforcing fiber matrix.
